(19) United States
(12) Patent Application Publication
(10) Pub. No.: US 2019/0023236 A1
(43) Pub. Date: Jan. 24, 2019

(54) AUTONOMOUS VEHICLE SERVICE STATION, SYSTEMS AND METHODS

(71) Applicant: RONALD MICHAEL WEBB, Elk Mound, WI (US)

(72) Inventor: RONALD MICHAEL WEBB, Elk Mound, WI (US)

(21) Appl. No.: 16/039,532

(22) Filed: Jul. 19, 2018

Related U.S. Application Data
(60) Provisional application No. 62/534,253, filed on Jul. 19, 2017.

(51) Int. Cl. B60S 5/02; E04B 1/348; E04B 1/94; E05F 15/73; B60L 11/18; H02S 20/23; H02J 7/35

(52) U.S. Cl. CPC B60S 5/02; E04B 1/34815; E04B 1/945; A62C 2/06; B60L 11/1824; H02S 20/23; H02J 7/355; E05F 15/73

(57) ABSTRACT

A portable facility and corresponding methods and systems for servicing autonomous vehicles, the facility having at least a first enclosure containing a fuel tank and defining a service space between a wall of the enclosure and a second enclosure containing a fuel tank, a roof positioned between the enclosures, a floor positioned between the enclosures, and large automatic doors positioned on opposite ends of the facility to accommodate entry/exit of autonomous vehicles which are guided to and/or by the facility for servicing.

### CROSS-REFERENCE TO RELATED APPLICATIONS

This application claims the benefit and priority of Provisional Patent Application Ser. No. 62/534,253 filed Jul. 19, 2017, for AUTONOMOUS VEHICLE SERVICE STATION, SYSTEMS AND METHODS under 35 U.S.C. Section 119(e), incorporated herein by reference in its entirety for continuity of disclosure.

### BACKGROUND OF THE INVENTION

### 1. Field of the Invention

This invention relates to aboveground portable service and fueling facilities designed to maintain vehicles, and related systems and methods.

### 2. Background Information

Autonomous vehicles are attracting increased interest. While portable fueling tanks and systems are known, there is room for improvement for use in servicing autonomous vehicles.

### SUMMARY OF THE INVENTION

Applicant has developed a fueling system or facility where one or more walls of the service facility are supported by a fire rated enclosure in which is positioned a fuel tank. In one aspect the system includes the use of two fire rated enclosures, each enclosure containing a fuel tank. The enclosures 30 define at least a portion of a perimeter of a receiving area for housing or servicing vehicles, such as autonomous vehicles. The wall of the enclosures, together with a roof and doors operate to provide an enclosed area. The enclosed area accommodates a variety of uses, including use as an autonomous vehicle service center. The enclosed area includes a roof and opposite garage-type doors (double-wide) for access into the enclosed area from opposite sides of the facility. The doors at opposite sides accommodate a one-way flow of traffic through the service station. The doors automatically open when a recognized autonomous vehicle is adjacent the doors. In further aspects charging pads are positioned within the service area for drive-over charging of autonomous vehicles. A battery charging system is incorporated with the facility.

The service station allows for fueling along the exterior perimeter of the facility while internally the autonomous vehicles (AVs) may be further serviced. The service station electronically communicates with the autonomous vehicles in the relevant service district. The autonomous vehicles are typically in need of power/fuel or repair or garden-variety servicing. The facility communicates with the AVs (or vice versa; or communication via a centralized server) so that the AVs may travel to the facility for servicing as needed. Data is shared between the facility and the AVs (and/or centralized or shared servers) to coordinate efficient servicing and stocking of products and scheduling of labor (i.e., efficient timing of servicing, ordering of fuel, oil, spare parts, working shifts, etc.). The facility includes a bathroom (57) and offices (58) for attendants. In one aspect, the fuel tank and all components for dispensing, recirculating and filling of the tank with fuel are positioned entirely within the fire rated enclosure. Doors open at opposite ends of the facility to allow access to the service station. The fire rated enclosures are designed to fit in a standard shipping container for easy transport so that they are easily relocated to accommodate for movement of the facility to other areas and/or for change-out with an alternative fire rated enclosure having updated or alternative features as technology changes.

In one aspect the invention includes an autonomous vehicle service station which electronically communicates with autonomous vehicles within, for instance, 40 miles of its location so vehicles in its service district “know” (or are programmed) where to go if the vehicle requires power/fuel or repair or other servicing. The facility is equipped with a tire center, battery charging center, a floor pad battery charger(s) for drive over charging and service center (shop with tools) to repair and replace damaged and broken parts on unattended cars and place them back into service. In one aspect the facility arrives in three 40 foot shipping containers and is installed on any flat surface such as a parking lot or pad. In alternatives, a fire rated enclosure includes a power generator along with a battery charger so that the entire facility is independently operated.

In a further aspect the invention includes a fire walled enclosure having a fuel tank positioned within a first section of the enclosure where a second section of the enclosure is configured for operations and/or storage associated with servicing of vehicles, and where the entire enclosure is positioned within an ISO container. The fuel tank includes dispensing components. The enclosure is a prefabricated module of a service station facility which is configured to be set in place for turn-key hookup and operation as a dispenser and service station.

In a further aspect, the invention consist of software and/or a system where multiple autonomous vehicles communicate with multiple service facilities (whether directly or indirectly via remote server and database components). The service facilities may be portable to optimize efficiency of the system.

The above partial summary of the present invention is not intended to describe each illustrated embodiment, aspect, or every implementation of the present invention. The figures and detailed description and claims that follow more particularly exemplify these and other embodiments and further aspects of the invention.

### BRIEF DESCRIPTION OF THE DRAWINGS

FIG. 1 is a perspective view of an autonomous vehicle service station in accordance with one aspect of the present invention.

FIG. 2 is a front view of the service station of FIG. 1 with the doors closed.

FIG. 3 is a side view of the service station of FIG. 1.

FIG. 4 is a top schematic view of the service station of FIG. 1 with portions removed for clarity.

FIG. 5 is a perspective view of the service station of FIG. 1.

FIG. 6 is a perspective view of the service station of FIG. 5 with portions removed and show transparently for clarity.

FIG. 7 is a perspective view of a further aspect of the invention and showing a service station partially contained in a standard shipping container.

FIG. 8 is a schematic diagram in accordance with a system aspect of the invention.

While the invention is amenable to various modifications and alternative forms, specifics thereof have been shown by way of example in the drawings and will be described in detail. It should be understood, however, that the intention is not necessarily to limit the invention to the particular embodiments, aspects and features described. On the contrary, the intention is to cover all modifications, equivalents, and alternatives falling within the spirit and scope of the invention and as defined by the appended claims.

### DETAILED DESCRIPTION OF THE INVENTION

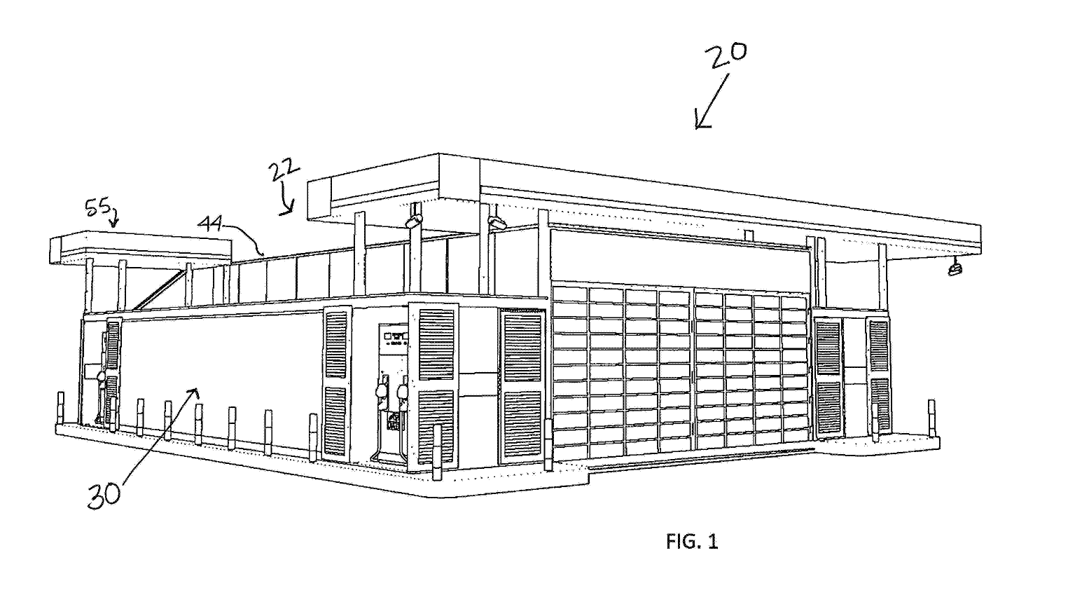

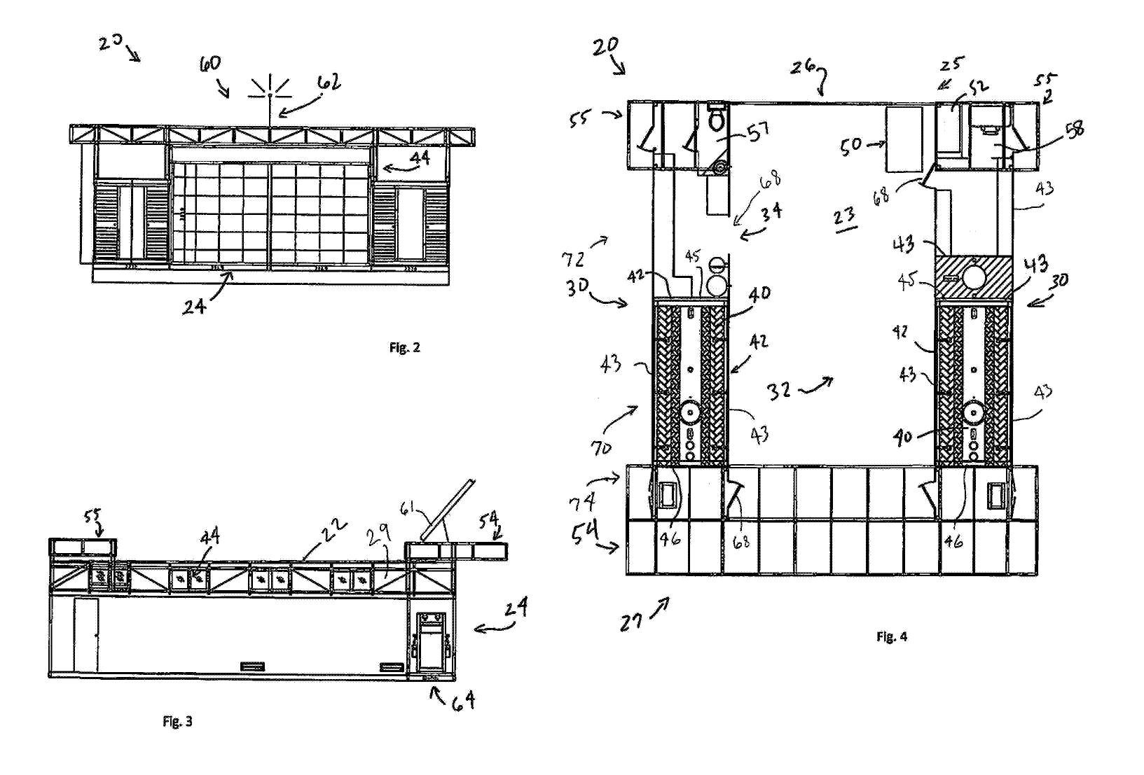

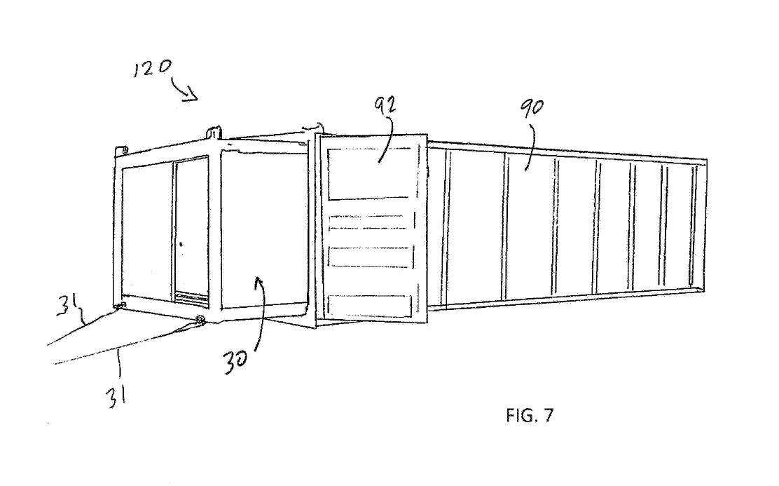

Referring to FIGS. 1-8, aspects of a facility 20 for servicing vehicles and for other purposes is shown. Systems 120, 200 and associated software aspects of the invention are also described. Facility 20 is a portable aboveground service facility designed to maintain vehicles, including autonomous vehicles (i.e., self-driving automobiles). While vehicles such as automobiles and autonomous automobiles may be used, additional vehicles such as busses, trucks, motorcycles, scooters, bicycles (including electrical bicycles), or other vehicles or equipment may be used in conjunction with the facility 20. In one aspect facility 20 is provided with standard motor vehicle service station equipment and products, such as standard tools for repair and maintenance, including air compressors, lifts, hand tools, diagnostic equipment and the like, together with fuel products, tires, oil, windshield wash and wipers, transmission fluid, lights/bulbs, and other service station or repair products. Facility 20 includes at least one fire resistant enclosure 30 containing a fuel tank 40. In one aspect facility 20 includes at least two fire resistant enclosures 30 separated to define a service space 32 configured to receive vehicles. Additional enclosures 30 may be used.

In one aspect, a first tank 40 is configured within a first fire resistant enclosure 30 and a second tank 40 is configured within a second fire resistant enclosure 30. The two enclosures 30, 30 define in part an inside perimeter 42 and service space 32. Tank 40 is a double-walled tank designed to hold liquid fuel and includes a secondary containment chamber designed to contain spills from the primary tank. Tank 40 is an Underwriters Laboratory (UL) listed tank with firewall 43. A firewall 43 (or multiple fire walls 43) are used in conjunction with tank 40. A firewall 43 in one aspect is positioned around the perimeter of tank 40.

A roof 22 spans between the enclosures 30, 30. The roof 22 in one aspect is supported by window walls 29 extending upward from the enclosures 30. Windows 44 are included in the window walls 29 to allow natural light to enter the service space 32. A floor 23 is positioned between the enclosures 30, 30 and in part defies the service space 32. In further aspects the enclosures 30 are set upon and/or mounted to a concrete slab (or pavement or other desired and appropriate surface), a portion of which is exposed in the service space 32 as a floor 23. A first door 24 is positioned at a first end 25 of facility 20. A second door 26 is positioned at a second end 27 of facility. In one aspect first door 24 and second door 26 are double-wide doors to accommodate ease of entry/exit. Doors 24, 26 may be roll-up doors, hinged doors or other types of door. Doors 24, 26 automatically open in response to the presence of an autonomous vehicle. In one aspect, a vehicle will send a signal to facility 20 which in turn will cause door 24 or door 26 to open/close as appropriate. In other aspects facility 20 detects the presence of a vehicle and automatically opens a door 24, 26. In operation multiple vehicles such as autonomous vehicles arrive at facility 20 for servicing. A vehicle in one example will be in close proximity to door 24, 26 which will automatically open to allow the vehicle to enter. The vehicle will automatically drive to a charging pad 50 for recharge of the vehicle battery or batteries. If another vehicle is already occupying the location at pad 50, the first vehicle will wait until the charged vehicle clears the area and will automatically position itself above pad 50. In one aspect multiple charging pads 50 are positioned about service space 32 so that multiple vehicles may be simultaneously charged. Software is utilized to determine a queuing priority among multiple vehicles to accommodate efficient and timely charging of the multiple vehicles and for ease of exit of a charged vehicle and entry of an uncharged vehicle. Vehicles may be arranged in a line or other configuration for efficient charging and with clear spaces or alleyways defined for vehicles to exit or fill designated charging locations above respective charging pads 50. A first door 24 and/or second door 26 allows vehicles to efficiently enter one side of facility 20, obtain servicing such as a battery charge or other service, and exit an opposite door 24, 26 of the facility for efficient flow of traffic.

In one aspect, enclosure 30 includes a fuel tank 40 at a first section 70 of the enclosure 30 with a second section 72 configured for use as a storage facility and/or for service operations on vehicles. Second section 72 may also be used as a shop with a workbench and storage area for tires and wipers or other equipment to service the vehicles. Second section 72 may also include bathroom facilities, water spigots, battery storage area, battery bank and charger for charging vehicles, discharge containers or other equipment for use in a service station facility.

FIG. 4 shows tank 40 positioned within a first section 70 of enclosure 30 (in one aspect at a front end 27 of enclosure 30). Tank 40 holds thousands of gallons of liquid fuel, for instance. Multiple tanks 40 may be positioned within the first section 70 as desired. In some instances no tank is inserted in first section 70. Different size tanks 40 may be utilized as desired. First section 70 in one aspect occupies approximately 50% of the space of enclosure 30. It may be appreciated that first section 70 may comprise a greater, or lesser, percentage of the space of enclosure 30. Enclosure 30 also includes a second section 72 (rear area 34 of enclosure 30) configured with a shop, tire/wearables area, workbench, bathroom and/or other features. Service equipment such as an air compressor, tire changer, water source, office, inventory shelves and storage, payment register, electrical equipment and charging equipment, tools or other service station equipment and inventory are positioned at the second section 72 (rear area 34). Enclosure 30 also includes third section 74 positioned opposite second section 72. A pump or pump terminal 64 is positioned within third section 74. Pump terminal 64 is a standard pump terminal for pumping fuel and is calibrated with standard weights and measures controls and payment mechanism. Service personnel or self-serve service may utilize pump terminal 64 for fueling of vehicles and other equipment. Third section 74 includes a door or doors which open externally of enclosure 30 so that pump terminal 64 may be utilized without having to access service space 32. In one aspect as shown in FIG. 4, first section 70 occupies less than 50% of enclosure 30 so that a desired larger area may be utilized for second section 72 and third section 74. In one aspect enclosure 30 includes an internal door or doorway 68 providing access to the second section 72 or third section 74 from the service space 32. Dispensing equipment is included with tank 40 and/or pump terminal 64 for dispensing fuel, such as electrical components, controllers, meters/gauges, filters, hoses and hose reels, alarms, generators, valves, pumps, breaker panel. Additional components for interior and exterior lighting and security are also provided at facility 20.

As further shown on FIG. 4, first section 70 includes fire wall 43 enclosing tank 40. A fire wall 43 completely surrounds tank 40. In one aspect a first internal firewall 45 is positioned between first section 70 and second section 72, and a second internal firewall 46 is positioned between first section 70 and third section 74. Also as shown in FIG. 4, in one aspect fire wall 43 operates as external fire wall 43 for first section 70, second section 72 and/or third section 74.

Floor 23 is defined between enclosures 30, 30. A car charge pad 50 in one aspect is positioned at floor 23 and is configured to charge a battery of a car or autonomous vehicle, where the car is positioned above the pad 50. A plurality of pads 50 may be presented about floor 23 so that a plurality of vehicles may be charged (even simultaneously). In one aspect pad 50 is a drive-over battery charging mechanism. The battery of a vehicle may be charged by simply positioning the vehicle over the pad. A charger 52 is configured to supply electrical charge to the pads 50 for charging multiple vehicles. Plug-in varieties of car charging systems are used in alternative aspects. A battery charging system is included in second section 72 which includes a battery or bank of batteries and a charger. The charging system also includes a solar panel 61 or plurality of solar panels 61 configured to charge the battery or batteries. The DC voltage of the rechargeable batteries is used to charge the vehicles.

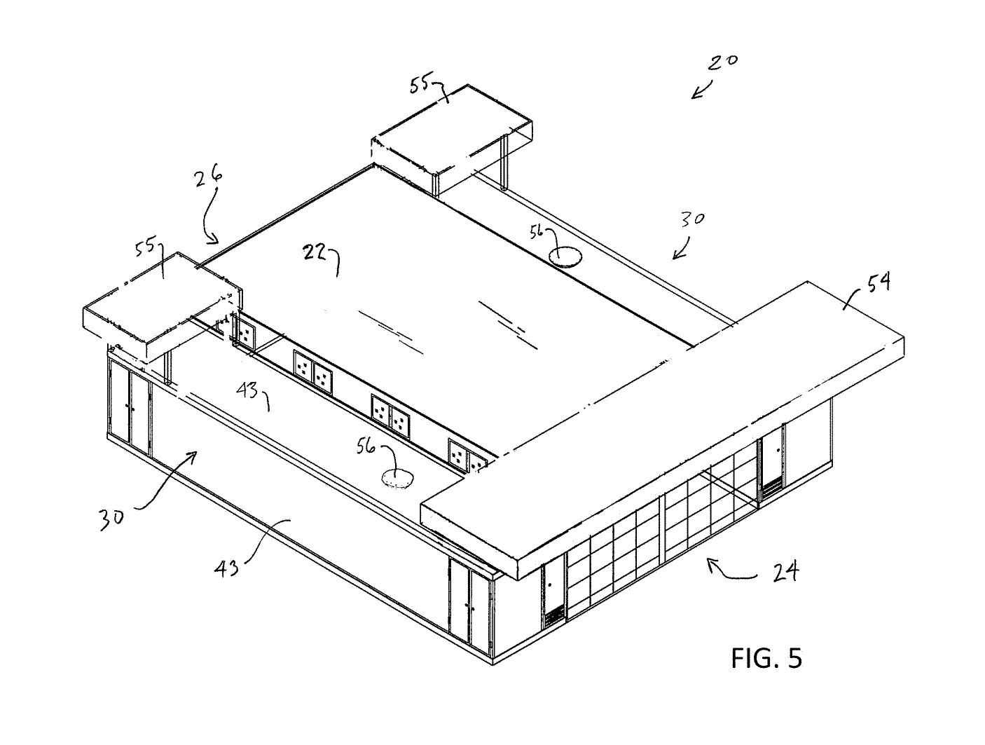

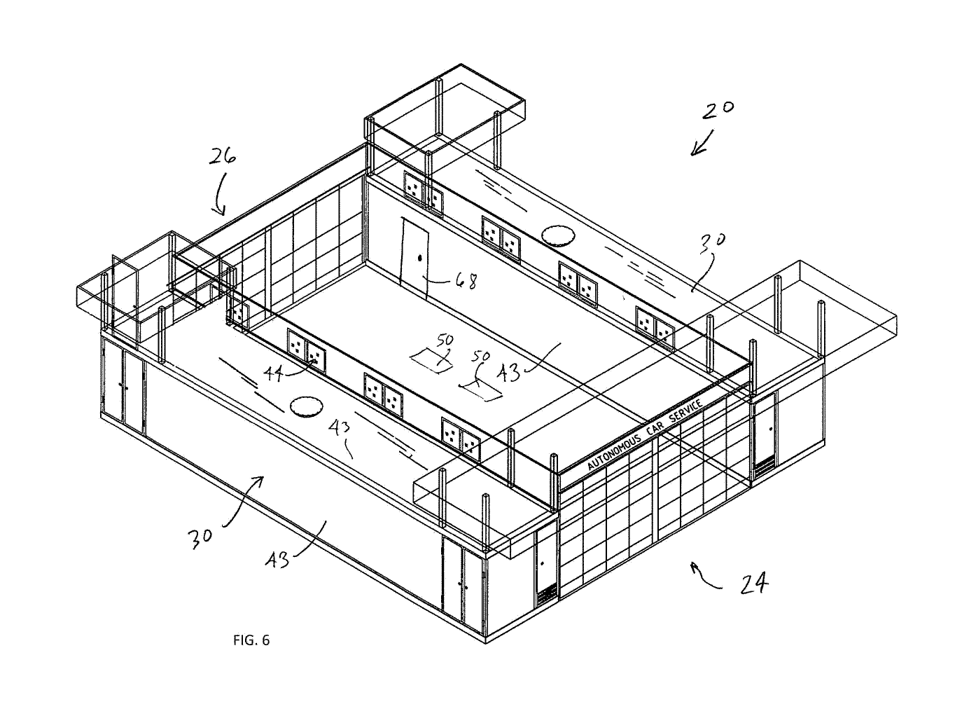

As shown in FIG. 5, a front awning 54 is positioned at a front end of facility 20 to accommodate shelter from rain and otherwise assist in maintaining a safe environment about doors 24. A back awning similar to front awning 54 may also be provided at second door 26. Additional awnings 55 are provided at or above entry points or doors which may provide access to facility 20. Awning 54 extends to provide protection at positions adjacent pumps 64. A manhole and manhole cover 56 is positioned at a top portion of enclosure 30 to provide access to tank 40 and for refill or maintenance purposes as needed.

In one aspect, two separate enclosures 30 containing tanks 40 are spaced apart on a parking lot, slab, or other flat or relatively flat surface. The enclosures 30 are designed to fit in standard shipping containers, such as container 90. Container 90 is an intermodal container manufactured according to specifications from the International Organization for Standardization (ISO) suitable for multiple transportation methods such as truck, rail, ship or air, etc. In one example container 90 is manufactured in accordance with ISO standards (such as ISO 1496 and ISO 668 or their equivalent, or other ISO standard), or a structure that shares the outer dimensions of a shipping container manufactured in accordance with ISO 1496 and ISO 668 (and also ISO 1161) or their equivalent sufficiently for the container to be stacked with shipping containers manufactured in accordance with the ISO standards or their equivalent (regardless of whether any or all of the containers are certified or not certified for stacking). ISO shipping containers may also have external dimensions and other parameters in accordance with ISO 668 and ISO 1161. The terms ISO 1496, ISO 1161, and ISO 668 refer to any and all versions or editions of those standards as published by the International Organization for Standardization (ISO), which standards are known to persons of skill in the art and are incorporated herein by reference to the extent legally permissible.

In one aspect an enclosure 30 is configured to fit within a 40 foot long shipping container 90. Two standard shipping containers 90 are used to ship two separate enclosures 30. A third 40 foot container 90 is used to store and transport the remaining items for use with facility 20. For instance, the third container 90 may contain the charge pads, roof structures, roof and window panels, awning and awning support structures, and other equipment used to assemble the facility 20. As such, the entire facility 20 may be transported via three standard shipping containers. The facility 20 is a modular structure, which is easy to assemble and disassemble. The prefabricated nature of the enclosures 30 accommodates ease of assembly of the structural components (fire walls, tanks, plumbing, electrical wiring and connections) and necessary testing of all of the equipment to assure operation prior to shipping. The enclosure 30 may be shipped to a variety of locations for use. In preparation for use of enclosure 30 a site may be configured with a flat slab or pavement, and with utilities such as water, sewer and electrical services. The prefabricated enclosure 30 having pre-installed and pre-tested working components and configured to fit within a standard shipping container accommodates easy transport, set-up, mounting, assembly and operation of facility 20.

FIG. 7 shows a system aspect 120 of the present invention in the nature of a system including a combined shipping container 90 and enclosure 30. Enclosure 30 is prefabricated to include the features as described herein (or at least some of the features) and is assembled and tested in the fabrication shop or manufacture plant. When modular assembly and testing is complete, enclosure 30 is stored within standard shipping container 90. Enclosure 30 may be slid horizontally into container 90 in one aspect. A container door 92 is closed to secure enclosure 30 completely within container 90. For removal, door 92 is opened and a cable 31, for instance, is secured to enclosure 30 for convenient sliding removal of enclosure 30 from container. System 120 may be combined with additional systems to construct facility 20.

In a further system aspect of the invention, autonomous vehicles (AVs) are programmed to use facility 20 for servicing. AVs may be programmed to utilize one of many facilities 20 as needed and as appropriate depending on the location of the AV and the facility 20. A facility 20 in one aspect includes a communication module 60 configured to communicate with AVs. In one aspect module 60 includes a program configured to send and/or receive data from AVs. An antenna or communication device 62 is used to send/receive signals to and from AVs. In other aspects, the AVs will include GPS or other mapping data and information and thus navigate about the roadways, including navigation to the location of facility 20. A plurality of facilities 20 are positioned about a city or other desired area for accommodating servicing of a plurality of AVs. In one aspect a centralized database and software programs are used to coordinate the actions of the AVs and the use and restocking (or repositioning) of facilities 20. Because facilities 20 are portable, a system of the invention includes continual optimization of the overall autonomous transportation system by modifying the location of the respective facilities 20 associated with the system. As demographics change, or as better demographic data is received, the locations of facilities within a city or county or other area can be adjusted to optimize service efficiency, including the saving of fuel and minimizing down-time due to travel to a facility 20 and/or the capacity for handling AVs at a particular facility 20 or set of facilities 20.

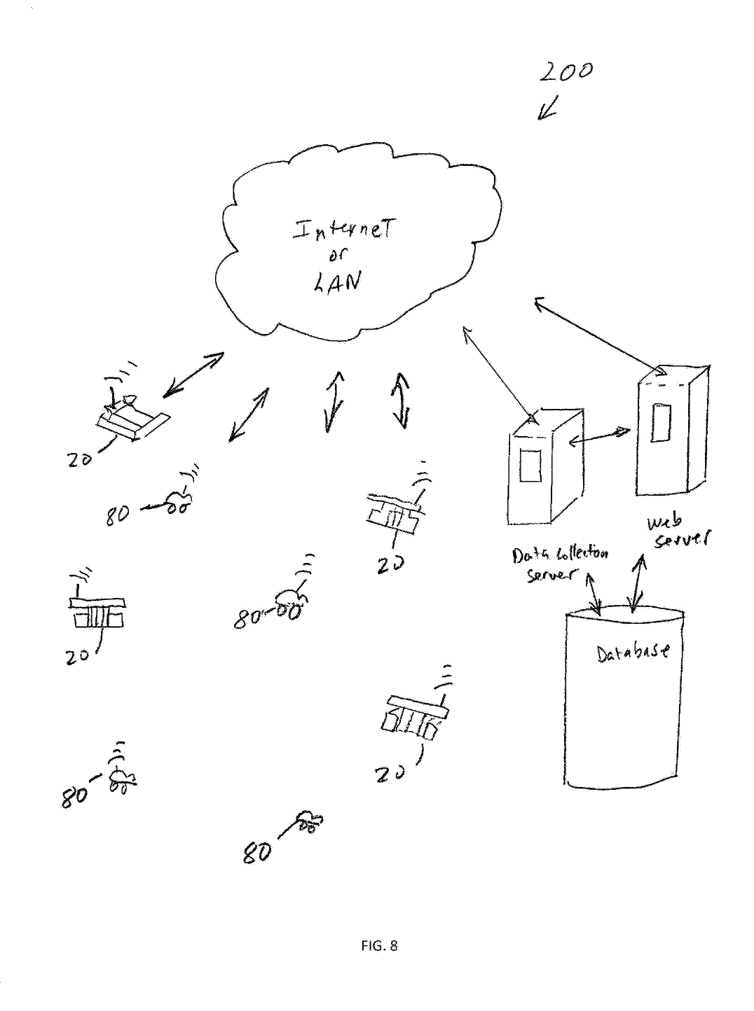

FIG. 8 depicts a further system aspect 200 of the invention. System 200 includes a plurality of facilities 20 as presented herein. The facilities 20 are positioned about an area of coverage, for instance at various locations within a metropolitan area or other region where numerous autonomous vehicles (AVs) 80 are provided. Each facility 20 includes equipment configured to allow the facility 20 to send and receive data information to or through a network to a server or servers. System 200 includes software, servers, databases to accommodate inventory delivery, ordering and management. The vehicles 80 are equipped with devices to send and receive data to the facilities 20 and/or to the servers in order to coordinate servicing or repair of vehicles 80. System 200 will track the respective resources present at respective facilities 20 (adjust as the resources are increase or decrease) and the resources and other data associated with the respective plurality of vehicles 80. When a vehicle 80 is in need of service (i.e., battery recharge, fuel refill, wiper replacement, oil change, tire rotation or replacement, cleaning, repair or other service) such conditions are sensed by sensors associated with the vehicle 80 and provided as data in an information signal communicated to servers. The program running at the servers is configured to determine when and what service is required (if any) of the respective vehicles 80. The software program is configured to command or instruct the vehicle 80 to travel to a particular facility 20 for servicing. System 200 is configured to optimize efficiency of where and when vehicles 80 are serviced. A particular vehicle 80 may be instructed to travel to a nearby facility 20, for instance, if such facility represents the optimal solution for the repair in the context of the entire network of facilities 20 and vehicles 80. In some instances, such as where a particular facility 20 is crowded or is out of a particular service item, or where a more distance facility has capacity or an optimal amount of service resources and products and labor available, the system is configured to instruct vehicle to travel to the alternative facility (not always based on a close proximity). Data trends and reports are configured to allow for management decisions on how to allocate resources at particular facilities 20, where to locate or move facilities, which facilities to supply with which products and in what quantities, etc. Sensors are provided for automatic real-time monitoring of resources and locations to optimize overall system productivity. Forecasting for repair or replacement of vehicles 80 is achieved with greater accuracy. System data may be monitored remotely. Servers and/or database may be located at any of the facilities or remotely.

In operation, facility 20 is assembled by transporting an enclosure 30 (or multiple enclosures) which house tank 40 and the other components of facility 20. Once assembled, AVs may be serviced at the facility 20 or at one of many different facilities 20. An AV will return or arrive at facility 20 when the AV is in need of service (which need is determined by software programming designed to determine when fuel/power or other services are needed). In one aspect, AVs are programmed to automatically queue along enclosure 30 and adjacent pump 64 for fueling. In this manner an attendant need only connect the fuel pump to the AV for filling (without having to position the AV). In alternatives, an alternative fueling pump is provided for fueling AV inside facility 20. The alternative fueling pump may also be located at other locations about facility 20. In further aspects, AVs are programmed to queue for use of charge pad 50 or one of a plurality of charge pads 50 presented within service space 32. Once an AV is serviced, it is available for use as intended and will exit facility 20 for standard operation as a taxi or other autonomous automobile purpose. A beacon is used to guide other AVs to facility 20 for continued servicing in one aspect. The facilities are continually monitored using software to control the replenishment of fuel, oil, lubricants, batteries and other items and store service records in a master database for assessing AV service life. Facility 20 complies with building codes and fire regulations, provides shelter over the entrances in case of inclement weather, inconspicuously blends within a residential or other areas, provides natural internal lighting for attendants servicing the AVs, is inexpensive compared to traditional buildings, and is portable. The extra wide doors accommodate AVs entering and exiting from opposite ends of facility 20 for efficient queuing.

In a further aspect, each of multiple AVs is equipped with a controller configured to coordinate communication with facility 20 and/or multiple facilities 20 (whether directly or via the cloud/internet). The controller is programmed such that an AV will attend servicing at one of a variety of facilities 20 depending on the circumstances (traffic, supply levels, distance, capacity at a facility, attendant shift timing, etc). A system is configured to coordinate multiple facilities 20 and multiple AVs, and the coordination is communicated by data sent wirelessly (or hard wired) among facilities 20 and AVs.

It should be understood, of course, that the foregoing relates to exemplary embodiments of the invention and that modifications may be made without departing from the spirit and scope of the invention as set forth in the following claims.

What is claimed is:

1. A facility for servicing vehicles, comprising:
a first fire resistant enclosure having at least a first fuel tank, the first enclosure defining at least a portion of a first internal wall of the facility;
a second fire resistant enclosure having at least a second fuel tank, the second enclosure defining at least a portion of a second internal wall of the facility;
a roof positioned between the enclosures and together with the first internal wall and the second internal wall in part defining a service space configured to receive vehicles;
a first door positioned at a first end of the facility and configured to allow vehicles to enter and/or exit the service space; and
a second door positioned at a second end of the facility opposite the first end of the facility and configured to allow vehicles to enter and/or exit the service space.

2. The facility of claim 1 where the first door automatically opens in response to the presence of an autonomous vehicle, the first door configured to allow the autonomous vehicle enter and/or exit the service space.

3. The facility of claim 1 further comprising at least one drive-over battery charging mechanism positioned at a floor within the service space.

4. The facility of claim 3 further comprising at least one solar panel associated with the facility and configured to charge at least one battery configured to provide a charge to an autonomous vehicle.

5. The facility of claim 1 further comprising a communication module configured to communicate facility and inventory data with a control system.

6. The facility of claim 1 further comprising at least one UL listed fire wall positioned between the first fuel tank and the service space.

7. The facility of claim 1 further comprising a service shop with equipment for servicing autonomous vehicles.

8. The facility of claim 7 further comprising bathroom and storage spaces for accommodating a vehicle service station.

9. The facility of claim 8 further comprising a tire center, battery charging center and service center to repair vehicles.

10. A facility for servicing vehicles, comprising:
a first enclosure which contains at least one fuel tank, the first enclosure defining at least a portion of a first internal fire wall of the facility;
a roof positioned between the first enclosure and a second fire wall and together with the first internal fire wall in part defining a service space configured to receive vehicles;
a first door positioned at a first end of the facility and configured to allow vehicles to enter and/or exit the service space; and
at least one drive-over battery charger positioned in the service space and configured to charge an autonomous vehicle.

11. The facility of claim 10 where the first enclosure is configured to be transported within a standard shipping container.

12. The facility of claim 10 further comprising a second enclosure which contains a fuel tank, and a second door positioned at a second end of the facility configured to automatically open due to the presence of an autonomous vehicle.

13. The facility of claim 10 comprising at least one fire wall positioned between the at least one fuel tank and the service space.

14. The facility of claim 13 where the fire wall is compliant with UL listing.

15. A facility for servicing vehicles, comprising:
an enclosure having a first section containing a first fuel tank and a second section configured for operations and/or storage associated with servicing vehicles;
the enclosure including a first fire wall forming an external wall of the first section and the second section, and a first internal fire wall separating the first section and the second section, the enclosure configured to fit within a standard shipping container.

16. The facility of claim 15 where the enclosure includes a third section in which is positioned a pump terminal for pumping fuel, and a second internal fire wall separating the first section and the third section.

17. The facility of claim 16 where the facility is positioned within a standard shipping container.

18. The facility of claim 17 further comprising at least one pipe connecting the pump to the fuel tank to accommodate supply of fuel and further comprising electrical wiring configured for hookup with a power source.

19. The facility of claim 15 where the second section includes components of a battery charging system configured to charge an autonomous vehicle.

20. The facility of claim 15 where the second section comprises a workshop designed for servicing vehicles.
